(19) United States
(12) Patent Application Publication
(10) Pub. No.: US 2019/0275894 A1
(43) Pub. Date: Sep. 12, 2019

(54) SYSTEM AND METHOD FOR DISTRIBUTED ENERGY EXCHANGE USING A TOKEN ECOSYSTEM

(71) Applicant: Toyota Research Institute, Inc., Los Altos, CA (US)

(72) Inventors: Matthew Amacker, Santa Clara, CA (US); Christopher Ballinger, Los Altos, CA (US)

(21) Appl. No.: 15/915,616

(22) Filed: Mar. 8, 2018

(51) Int. Cl. B60L 11/18; G06Q 20/36; H04L 9/06; H04L 29/08

(52) U.S. Cl. CPC B60L 11/1848; H04L 67/1042; H04L 9/0637; G06Q 20/3674

(57) ABSTRACT

System, methods, and other embodiments described herein relate to improving distribution of power using an internal battery of an electric vehicle. In one embodiment, a method includes, in response to detecting establishment of an electrical connection between the electric vehicle and a station, determining attributes of the electrical connection with the station that indicate at least a relationship between the electric vehicle and the station. The method includes transferring electric charge between an internal battery of the vehicle and the station according to at least the attributes of the electrical connection by performing one of i) discharging the electric charge to the station from the internal battery to offset electric demand at a location associated with the station according to at least the relationship, and ii) charging the internal battery of the vehicle from the station to store surplus electric supply.

### TECHNICAL FIELD

The subject matter described herein relates, in general, to a system and method for using an internal battery of an electric vehicle to selectively store and distribute power and, more particularly, to using the internal battery to shift electric from peak supply to peak demand while also providing for distributing the power independently of an electric utility grid using a token ecosystem that facilitates the exchange of power between the electric vehicle and various stations.

### BACKGROUND

Electric vehicles are increasing in numbers as, for example, a manner of providing environmentally conscious transportation. However, the increased number of electric vehicles can increase a burden on traditional electric utility grids. This increased burden can complicate existing difficulties with supplying electricity during peak demand on the electric utility grids. Moreover, in addition to complications with increasing demand on the electric utility grid, the advent of renewable energy sources such as solar and wind energy can supplement the electric utility grid and/or provide independence from the electric utility grid. However, peak supply from such sources is generally cyclical and often fails to correlate with peak demand, which can result in lost energy production. Additionally, separate storage solutions for retaining this energy can be quite costly. Consequently, various difficulties with providing electric charging and storage can complicate transitioning to renewable sources of energy.

### SUMMARY

In one embodiment, example systems and methods relate to a manner of using internal batteries of electric vehicles to store electric and subsequently distribute the electric using a token ecosystem. For example, while individual vehicles may be used in many different ways, commonly such vehicles are driven for short periods and then remain parked at residences, parking garages, and so on. Moreover, while the electric vehicles may be charged at charging stations located at these different places, trips navigated by the electric vehicles often do not consume a whole or even a majority of a capacity of the internal battery. Thus, the internal batteries of electric vehicles in combination with disclosed systems and methods represent a dynamic and distributed electric storage resource that can be leveraged to shift electric from periods of peak supply to peak demand, transfer electric charge geographically, deliver electric to locations that are not connected with the electric utility grid, and so on. In other words, the disclosed systems and methods leverage the storage capacity of the electric vehicle as a commodity that can be, for example, contracted to various locations and/or the electric utility grid to store and/or deliver power at designated times.

Therefore, the disclosed systems and methods generally function to monitor charge levels of the internal battery, detect when the vehicle is connected with a station, determine attributes of the station and/or a location associated with the station, and transfer electric charge between the internal battery and the station according to various conditions. The noted conditions can include agreements (e.g., futures contracts), time of day, current demand, current supply, and so on. Moreover, the noted systems and methods further implement, in one embodiment, a token ecosystem that serves as a means for facilitating the distributed transfer of the electric by providing an electronic currency that is also implemented in a distributed manner. For example, the electronic currency is a blockchain-based cryptocurrency that provides for decentralized exchanges in support of the transfer of electric between the vehicle and a station. In this way, the systems and methods disclosed herein improve upon how the vehicle stores and distributes power with various stations.

In one embodiment, a transfer system for improving the distribution of power using an internal battery of an electric vehicle is disclosed. The transfer system includes one or more processors and a memory communicably coupled to the one or more processors. The memory stores a monitoring module including instructions that when executed by the one or more processors cause the one or more processors to, in response to detecting establishment of an electrical connection between the electric vehicle and a station, determine attributes of the electrical connection with the station that indicate at least a relationship between the electric vehicle and the station. The memory stores a charging module including instructions that when executed by the one or more processors cause the one or more processors to transfer electric charge between an internal battery of the electric vehicle and the station according to at least the attributes of the electrical connection by performing one of i) discharging the electric charge to the station from the internal battery to offset electric demand at a location associated with the station according to the relationship, and ii) charging the internal battery of the vehicle from the station to store surplus electric supply.

In one embodiment, a non-transitory computer-readable medium for improving the distribution of power using an internal battery of an electric vehicle and including instructions that when executed by one or more processors cause the one or more processors to perform one or more functions is disclosed. The instructions include instructions to, in response to detecting establishment of an electrical connection between the electric vehicle and a station, determine attributes of the electrical connection with the station that indicate at least a relationship between the electric vehicle and the station. The instructions include instructions to transfer electric charge between an internal battery of the electric vehicle and the station according to at least the attributes of the electrical connection by performing one of i) discharging the electric charge to the station from the internal battery to offset electric demand at a location associated with the station according to the relationship, and ii) charging the internal battery of the vehicle from the station to store surplus electric supply.

In one embodiment, a method for improving the distribution of power using an internal battery of an electric vehicle is disclosed. The method includes, in response to detecting establishment of an electrical connection between the electric vehicle and a station, determining attributes of the electrical connection with the station that indicate at least a relationship between the electric vehicle and the station. The method includes transferring electric charge between an internal battery of the vehicle and the station according to at least the attributes of the electrical connection by performing one of i) discharging the electric charge to the station from the internal battery to offset electric demand at a location associated with the station according to at least the relationship, and ii) charging the internal battery of the vehicle from the station to store surplus electric supply.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a transfer system that is associated with controlling the distribution of power from an electric vehicle.

FIG. 3 illustrates one embodiment of a method associated with distributing power using an internal battery of an electric vehicle.

FIG. 4 illustrates one embodiment of a method associated with exchanging payment related to the distribution of power.

FIG. 5 illustrates an example configuration of an electric vehicle connected to a charging station.

FIG. 6 illustrates an example configuration of two electric vehicles directly connected for exchanging electric charge.

FIG. 7 illustrates an exemplary power grid layout.

### DETAILED DESCRIPTION

Systems, methods, and other embodiments associated with improving the distribution of power through the use of internal batteries of electric vehicles are disclosed. As mentioned previously, while electric vehicles are becoming more common, the electric vehicles have a potential to increase an electric load on existing electric infrastructure. However, the electric vehicles and, in particular, the internal high-capacity batteries of the electric vehicles represent a resource that can be leveraged in order to offset at least some of the noted difficulties.

For example, electric vehicles may spend more time parked at a residence, in a parking garage or at other locations than actually being driven. In other words, as with fossil-fuel-based vehicles, electric vehicles are generally used for short trips/commutes and are otherwise parked and waiting for use. Along the same conceptual line of reasoning, the electric vehicles generally do not consume a full electric charge that is stored within the internal batteries when used in this manner.

While some operators may experience range anxiety when presented with the idea of fluctuating levels of charge within their electric vehicle to support the functions described herein, such concerns are generally without cause and are alleviated through the disclosed fail-safes of charge thresholds and/or benefits of participating in the exchange of electric as described. In either case, the internal batteries of these vehicles generally sit idle and are underutilized as a resource for storing charge produced during peak supply, distributing charge between locations, and so on.

Moreover, while the electric vehicles may be charged at different locations, trips navigated by the electric vehicles often do not consume a whole or even a majority of a capacity of the internal battery. Thus, the internal batteries of electric vehicles in combination with disclosed systems and methods represent a dynamic and distributed electric storage resource that can be leveraged to shift electric both temporally and geographically in a manner that is, for example, independent of the electric utility grid. In other words, the disclosed systems and methods leverage the storage capacity of the electric vehicle as a commodity that can be, for example, contracted to various locations and/or the electric utility grid to store and/or deliver power at designated times.

Therefore, in one embodiment, a transfer system monitors for a connection with a station by determining when an electrical connection is established between the vehicle and the station. When detected, the transfer system identifies attributes about the electrical station, a location associated with the electrical station, whether a relationship (e.g., futures contracts or other agreement) is presently in place, whether a direct request for discharging/storing was issued, and so on. The transfer system can then assess the various attributes in combination with, for example, a current state of charge (SOC) of the internal battery of the vehicle, planned routes, predicted routes, threshold charge levels, a present location, and so on. In general, the transfer system accounts for a myriad of factors relating to the vehicle and aspects affecting the vehicle.

In either case, the transfer system determines whether to charge the battery or discharge the battery according to the noted attributes. By way of example, the transfer system may determine that the battery is to be charged when the vehicle is parked in a parking garage during the day. This charging may be part of an agreement for offsetting peak supply with peak demand. That is, the vehicle is charged during the day when supply is at peak and then discharges the electric at night when at a separate location and when, for example, demand is at peak.

Consequently, the disclosed transfer system and methods generally function to monitor charge levels of the internal battery, detect when the vehicle is connected with a station, determine attributes of the station and/or a location associated with the station, and transfer electric charge between the internal battery and the station according to various conditions such as obligations under contracts, according to specific requests, and so on.

In support of the charging and discharging activities, the transfer system and methods further implement, in one embodiment, a token ecosystem that serves as a means for facilitating the distributed transfer of the electric by providing an electronic currency. That is, the basis for simplifying and facilitating the exchanges is the electronic currency, which is, for example, a blockchain-based cryptocurrency that provides for decentralized exchanges in support of the transfer of electric between the vehicle and a station. In general, the token ecosystem provides for a monetary exchange between parties without involving a centralized clearinghouse. In this way, the systems and methods disclosed herein improve upon how, when, and where the vehicle stores and distributes power among stations.

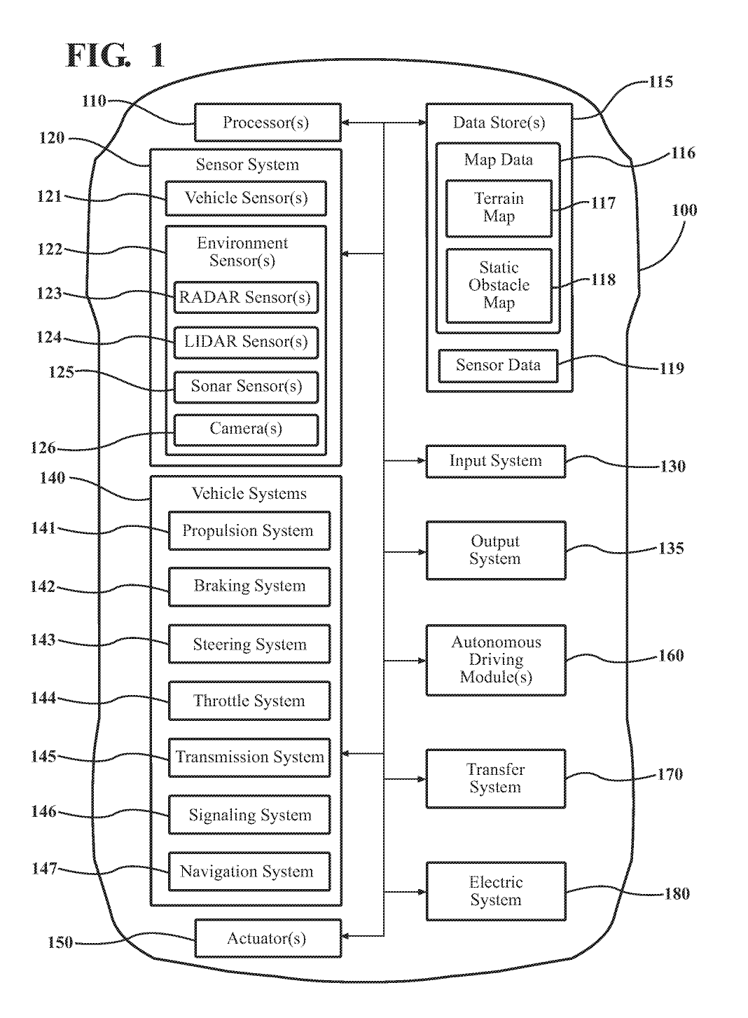

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, the vehicle 100 may be any robotic device or form of motorized transport that, for example, includes an internal battery, and thus benefits from the functionality discussed herein.

As illustrated, the vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. Additionally, while the various elements are shown as being located within the vehicle 100 in FIG. 1, it will be understood that one or more of these elements can be located external to the vehicle 100. Further, the elements shown may be physically separated by large distances.

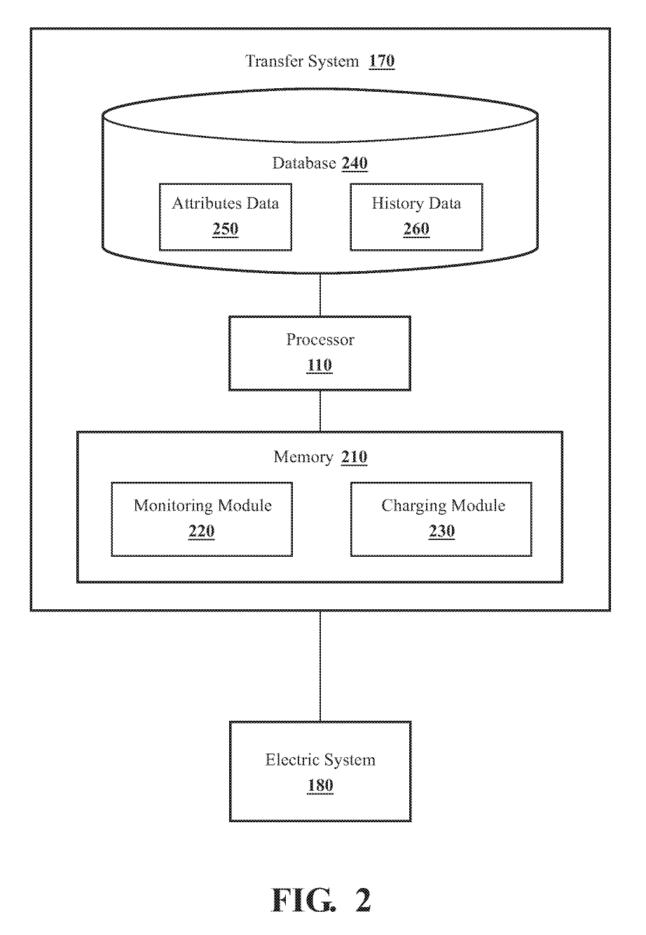

Some of the possible elements of the vehicle 100 are shown in FIG. 1 and will be described along with subsequent figures. However, a description of many of the elements in FIG. 1 will be provided after the discussion of FIGS. 2-7 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In either case, the vehicle 100 includes a transfer system 170 that is implemented to perform methods and other functions as disclosed herein relating to transferring electric between the vehicle 100 and at least one station that is associated with a locality. The noted functions and methods will become more apparent with a further discussion of the figures. Moreover, in one embodiment, the vehicle 100 is an electric vehicle that includes an electric system 180 with at least an internal battery of the vehicle 100. In further aspects, the electric system 180 includes additional electrical components to facilitate the charging/discharging such as inverters, controllers, and so on. In either case, the electric system 180 includes the internal battery of the vehicle 100, which may be a lithium-ion battery, lead-acid battery, a nickel metal hydride battery, a molten salt battery, a collection of lithium-ion batteries, or another suitable type of battery. As a general matter, whichever type of battery is included with the electric system 180 of the vehicle 100, the battery is configured to store a sufficient charge for powering propulsions systems (e.g., electric motors) of the vehicle 100 over a range that is comparable with, for example, traditional vehicles.

With reference to FIG. 2, one embodiment of the transfer system 170 of FIG. 1 is further illustrated. The transfer system 170 is shown as including a processor 110 from the vehicle 100 of FIG. 1. Accordingly, the processor 110 may be a part of the transfer system 170, the transfer system 170 may include a separate processor from the processor 110 of the vehicle 100 or the transfer system 170 may access the processor 110 through a data bus or another communication path. In one embodiment, the transfer system 170 includes a memory 210 that stores a monitoring module 220 and a charging module 230. The memory 210 is a random-access memory (RAM), read-only memory (ROM), a hard-disk drive, a flash memory, or other suitable memory for storing the modules 220 and 230. The modules 220 and 230 are, for example, computer-readable instructions that when executed by the processor 110 cause the processor 110 to perform the various functions disclosed herein.

Accordingly, the monitoring module 220 generally includes instructions that function to control the processor 110 to determine when the vehicle 100, and, in particular, the electric system 180, establish a connection with a station. Thus, the monitoring module 220 through one or more sensors of the electric system 180 and/or one or more sensors of the sensor system 120 detects when the vehicle 100 is connected with a station. In general, as provided for herein, the monitoring module 220 receives sensor data from at least the electric system 180 in the form of a connection sensor detection, a voltage detection, or another suitable determination as may be implemented to identify when a charging cable is connected between the vehicle 100 and a station. However, the monitoring module 220, in various embodiments, may also receive additional sensor information about a connection to the station. For example, the monitoring module 220 may determine GPS coordinates, may query control components of a station for attributes (e.g., station ID, charging characteristics), determine planned routes from a navigation system 147, predicted routes that are indicative of how the vehicle 100 is routinely driven, history of prior charging/discharging in relation to the station, determine if an agreement/contract is in place relating to the station/location, determine a number of charge/discharge cycles for the battery, and so on.

Moreover, the monitoring module 220 applies, in one embodiment, object recognition functions to scan data acquired from a LIDAR 124 or other sensor to distinguish between objects or various aspects of a location. For example, in one approach, the monitoring module 220 identifies a presence of a station, whether a cable is connected between the station and the vehicle 100, and so on using sensor data from the sensor system 120. Thus, the monitoring module 220, in one embodiment, uses information about the identified objects and aspects of the environment as a verification of whether the vehicle 100 is connected with the station.

Furthermore, the station generally functions as a link to the electric infrastructure of a location. In various implementations, the stations provide for transferring electric charge to the vehicle 100 through the electric system 180 of the vehicle 100, and/or receiving charge from the vehicle 100 via the electric system 180. Therefore, the station can include additional components to regulate, meter, condition, and to generally provide for transferring electric between the vehicle 100 and the station. In various implementations, the station can be connected with different electric infrastructure. For example, in one aspect, the station is simply connected with an electric utility grid in a vehicle-to-grid (V2G) type of configuration.

However, in further aspects, the station is electrically connected with a renewable energy source (e.g., solar, wind, hydro, etc.) that is independent of an electric utility grid or supplemental to the electric utility grid. Accordingly, the station may provide a connection to a bank of batteries in place of the electric utility grid. Additionally, the station is, in one embodiment, a mobile station that is integrated with another mobile vehicle such as another electric vehicle, a recreational vehicle (RV), and so on. Similarly, in one approach, the station is a temporary electric system that is setup for camping, emergency response, and so on. In either case, the station is configured to transfer power with another device in order to improve power distribution for a location associated therewith. As an additional note, while a single station is generally discussed, the stations may occur individually or in groups as may be the case when implemented in a parking garage or other such facility.

Furthermore, in one embodiment, the transfer system 170 includes the database 240. The database 240 is, in one embodiment, an electronic data structure stored in the memory 210 or another data store and that is configured with routines that can be executed by the processor 110 for analyzing stored data, providing stored data, organizing stored data, and so on. Thus, in one embodiment, the database 240 stores data used by the modules 220 and 230 in executing various functions. In one embodiment, the database 240 stores attributes data 250 along with, for example, history data 260 and/or other information that is used by the modules 220 and 230.

In one embodiment, the attributes data 250 includes information obtained about a current station, information about previous connections with the same or other stations, information about the vehicle 100 and the internal battery, stored information about agreements (e.g., futures contracts) between the vehicle 100 and a location or collection of locations, and so on. The history data 260, in one embodiment, includes information about past charging/discharging cycles, previous behaviors (e.g., requests to charge, cancellations of charges/discharges, etc.), and so on. Furthermore, the history data 260 also includes, in one embodiment, information about previous routes of the vehicle 100, and other driving behaviors of the vehicle 100. Thus, in various implementations, the charging module 230 uses the history data 260 and the attributes data 250 to make decisions about charging/discharging the internal battery of the vehicle 100. As one example, the charging module 230 predicts upcoming routes (e.g., commute between work and home) as a function of previously logged routes/routines to determine a threshold state of charge for the internal battery that is likely required for an upcoming trip.

In either case, the monitoring module 220, generally functions to monitor for the establishment of a connection between the vehicle 100 and a station and also to collect the information that is stored in the database 240. In this way, the charging module 230 can subsequently use the information and knowledge of the connection to determine whether to charge/discharge the internal battery and to what extent to do so.

Accordingly, in one embodiment, the charging module 230 generally includes instructions that function to control the processor 110 to analyze the attributes including at least a current state of charge of the internal battery so that the charging module 230 can determine whether to charge or discharge the battery to the station and to what extent. That is, depending on factors such as predicted charge needed for upcoming travel, current supply/demand of electric, conditions of an agreement to provide charge to the station or another station, and so on, the charging module 230 causes the electric system 180 of the vehicle 100 to charge or discharge power from the internal battery. Moreover, the charging module 230, in one embodiment, also manages enrollment in a token ecosystem by exchanging tokens with the station according to the transfer of power. That is, for example, the charging module 230 automatically exchanges an electronic cryptocurrency with the station as payment for transferring the electric charge. In further aspects, the payment may occur at a temporally shifted time in relation to the actual electric charge transfer such as when an agreement is initiated, subsequently as a credit payment for electric charge acquired or provided through a credit agreement, and so on.

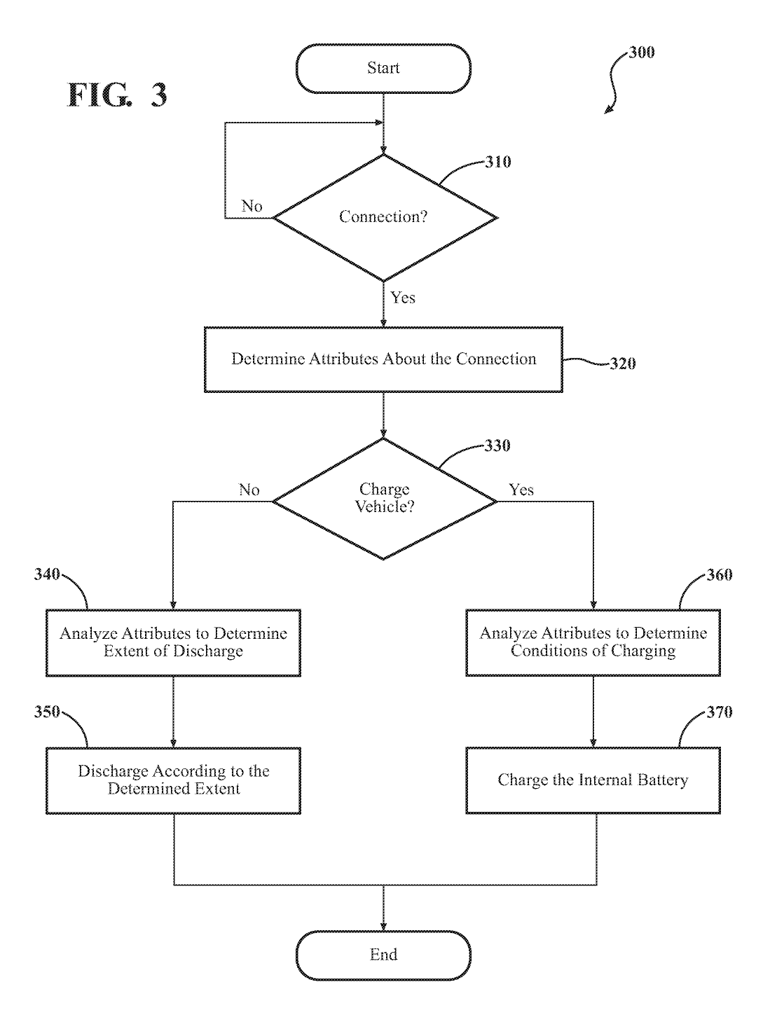

Additional aspects of improving the distribution of power through the use of internal batteries of electric vehicles will be discussed in relation to FIG. 3. FIG. 3 illustrates a flowchart of a method 300 that is associated with detecting when the vehicle 100 connects with a station and managing a transfer of power associated with the connection. Method 300 will be discussed from the perspective of the transfer system 170 of FIGS. 1, and 2. While method 300 is discussed in combination with the transfer system 170, it should be appreciated that the method 300 is not limited to being implemented within transfer system 170, but is instead one example of a system that may implement the method 300.

At 310, the monitoring module 220 monitors for the establishment of a connection between the vehicle 100 and a station. In one embodiment, the monitoring module 220 monitors sensor signals that indicate when an electrical cable is connected between the vehicle 100 and the station. For example, a connector assembly of the vehicle 100 can include a sensor that provides an electronic signal upon insertion of an electric cable. In further aspects, the monitoring module 220 detects a change in voltage within the electrical system 180 that is induced when the electrical cable is connected. As a general matter, the monitoring module 220 can leverage purposely provided sensors integrated with the electrical system 180 and/or other sensors of the sensor system 120 in order to detect when the vehicle 100 is connected with a station. Moreover, it should be appreciated that in further aspects, the connection can be a wireless charging connection and thus the monitoring module 220 then determines the establishment of the electrical connection according to a wireless communication/detection means.

At 320, the monitoring module 220 determines attributes of the connection. In one embodiment, the monitoring module 220 determines the attributes by determining physical characteristics of the connection, policy characteristics of the connection, and additional metadata about the vehicle 100 and the particular location that is associated with the station. For example, the policy characteristics include agreements, contracts (e.g., futures contracts), specific requests from a station for a charge, and other relationships that presently exist between the vehicle 100 and the station or an owner of the station, which may dictate aspects of how the vehicle 100 charges/discharges electricity in association with the station.

By way of example, the monitoring module 220 stores a ledger that identifies agreements in place for the vehicle 100 and locations and/or particular stations that correspond with the agreements. The agreements are, for example, futures contracts, credit agreements, or other agreements under which the vehicle 100 may be obligated to store electric charge on behalf of the station during, for example, periods of peak production, and discharge the electric charge at the same or a different location during periods of peak electric demand or as otherwise specified. In this way, the internal battery of the vehicle 100 is leveraged to shift electric charge temporally and/or spatially.

The physical characteristics generally can include aspects relating to a configuration of the station (e.g., charging capacity), whether the station is connected with the electric utility grid or is independent, whether the connection to the vehicle 100 is secured, and so on. Additionally, the metadata includes aspects relating to current conditions of the vehicle 100 (e.g., battery health), information relating to forecasted power consumption by the vehicle 100 (e.g., predicted/planned route charge requirements), a rating/score associated with past charging/discharging of the vehicle 100, owner/driver preference charge thresholds (e.g., minimum acceptable charge), a duration of stay at the station, and so on.

In one embodiment, the monitoring module 220 determines the score for the vehicle 100 according to at least previous behavior of the vehicle 100 in relation to transferring the electric charge and fulfilling obligations under the relationship/contract with the station and/or other stations. Moreover, the score may also include factors for available storage in the battery of the vehicle 100. In either case, the monitoring module 220 monitors behaviors of the vehicle 100 such as charging during peak demand, meeting/failing to meet obligations under various agreements, and so on. Each of the different factors contribute to the overall score in a positive or negative manner depending on the particular behavior/condition. Thus, the score generally embodies how reliable the vehicle 100 is at participating in the commoditizing of electric storage of the internal battery with the vehicle 100. Thus, exchange rates, charging/discharging preference, and/or other preferences offered to the vehicle 100 may be adjusted according to the score.

At 330, the charging module 230 determines whether the internal battery is to be charged or discharged. In one embodiment, the charging module 230 analyzes the attributes determined at 320 in order to determine whether the current time, contractual obligations, current state of charge, planned/predicted routes, and other factors indicate that the internal battery is to be charged or discharged at a present time. Additionally, the charging module 230 analyzes the attributes to determine obligations under various agreements when weighing whether the vehicle 100 is to charge or discharge the internal battery. In further aspects, the charging module 230 performs the determination according to a specific electronic request by an operator to charge and/or discharge the battery.

As a further note, it should be appreciated that while the vehicle 100 may be party to a futures contract or other agreement that obligates the vehicle 100 to temporally and/or spatially shift electric charge using the internal battery according to a defined schedule of transfers, the charging module 230 logically determines according to the noted factors whether the battery will be charged or discharged. That is, the charging module 230 generally will not permit the internal battery to be depleted of electric charge to an extent such that operation is not feasible within a near-term window. Of course, in various implementations, such settings may be adjusted to permit full discharge of the battery when, for example, the vehicle is set to an away mode for vacation, manually directed to do so, or according to another factor.

In either case, the charging module 230 makes a determination at 330 to discharge the vehicle 100 as discussed further at blocks 340 and 350 or to charge the vehicle 100 as discussed further at blocks 360 and 370. It should be appreciated that the charging module 230 can analyze and determine the parity between charging and discharging and aspects related thereto in several different ways depending on particular implementation choices. However, as a general approach, the charging module 230 employs a heuristic that weighs the noted attributes according to defined and/or learned weights and produces a value which can then be compared to a determination threshold. In this way, the charging module 230 can learn when to charge and discharge the battery in order to balance the various considerations.

At 340, the charging module 230 analyzes the attributes to identify characteristics of the transferring including an amount of the electric charge that is to be transferred. That is, for example, depending on various factors identified in the attributes such as a minimum charge threshold, an opportunity to further charge subsequent to a present discharge, a predicted/planned route, obligations according to one or more agreements, and so on, the charging module 230 can determine a particular amount of electric to discharge into the station. Moreover, the charging module 230 can also determine further aspects about the discharging such as a rate/speed of discharge, an exchange rate that is to be acquired for the discharge, and so on. As a further matter, in one embodiment, the charging module 230 electronically prompts an operator to approve of the discharge and any noted conditions (e.g., exchange rate) of the discharge, prior to proceeding to block 350.

At 350, the charging module 230 controls the electric system 180 to discharge to the station from the internal battery of the vehicle 100. In one embodiment, the charging module 230 controls the discharge by electronically querying the electric system 180 to initiate the discharge. In further aspects, the charging module 230 controls a series of communications between the station and the vehicle 100 to setup and initiate the discharge. In either case, the charging module 230 provides the electric charge to the station from the internal battery of the vehicle 100. Thus, the charging module 230 facilitates the transfer of the electric charge to an electric utility grid if the station is connected thereto or to infrastructure associated with the station that is independent of the electric utility grid. In either case, discharging the electric to the station can provide for offsetting peak demand through the use of the internal battery of the vehicle 100.

At 360, the charging module 230 analyzes the attributes to identify characteristics of the transferring including an amount of the electric charge that is to be transferred. That is, for example, depending on various factors identified in the attributes such as a current state of charge, a predicted/planned routes, obligations according to one or more agreements, current supply, and so on, the charging module 230 can determine a particular amount of electric to charge into the internal battery from the station. Moreover, the charging module 230 can also determine further aspects about the charging such as a rate/speed of charge that is available, an exchange rate that is to be acquired for the transferred electric, and so on. As a further matter, in one embodiment, the charging module 230 electronically prompts an operator to approve of the charging and any noted conditions (e.g., exchange rate), prior to proceeding to block 370.

At 370, the charging module 230 transfers electric charge into the internal battery of the vehicle according to the attributes. As noted previously, in one embodiment, the charging occurs as a manner of shifting/storing electric produced during a peak production period from sources such as, for example, solar. However, the determination of whether the internal battery is to be charged and to what extent the battery is charged depends on further factors as noted above. Accordingly, in one embodiment, the charging at 370 can occur in response to a determination by the charging module 230 that a totality of the factors exceed a charging threshold that indicates when the internal battery is to be charged. Thus, such factors as the exchange rate, contractual obligations, planned/predicted routes, current electric supply, and so on can factor into when the internal battery is charged.

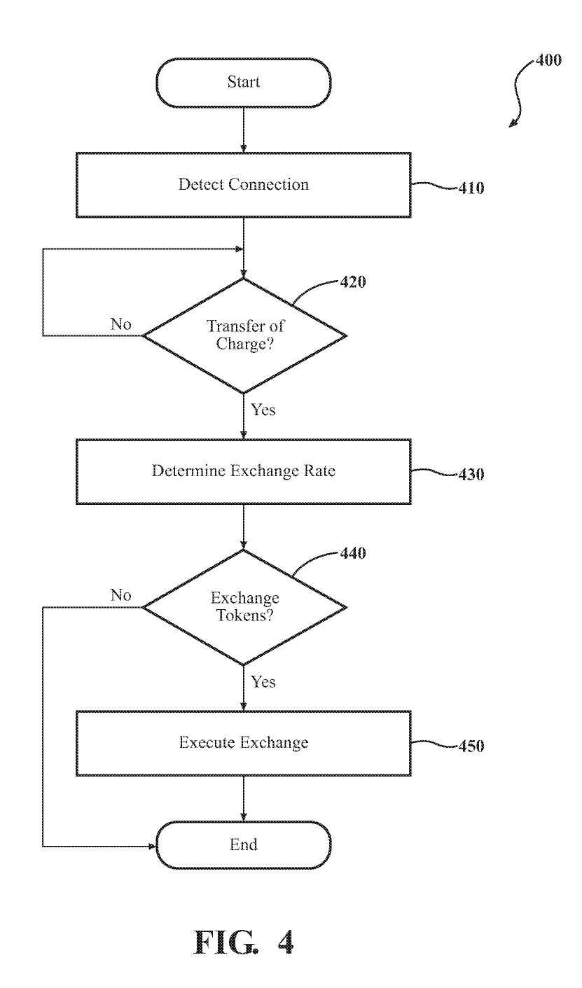

Additional aspects of improving the distribution of power through the use of internal batteries of electric vehicles and a token ecosystem will be discussed in relation to FIG. 4. FIG. 4 illustrates a flowchart of a method 400 that is associated with the exchange of payment using a token ecosystem as a mode of exchanging payment in connection with the transfer of power as previously described. Method 400 will be discussed from the perspective of the transfer system 170 of FIGS. 1, and 2. While method 400 is discussed in combination with the transfer system 170, it should be appreciated that the method 400 is not limited to being implemented within transfer system 170, but is instead one example of a system that may implement the method 400.

At 410, the monitoring module 220, as discussed previously in relation to 310 of method 300, monitors for a connection with a station and upon detecting such a connection proceeds to block 420.

At 420, the monitoring module 220 determines whether electric charge is to be transferred between the vehicle 100 and the station. That is, the monitoring module 220 determines whether the vehicle 100 is being charged, is discharging to the station, or is in a standby mode and not transferring charge. If the vehicle 100 is in standby, then monitoring module 220 continues to monitor for a transition (e.g., change in the circumstances) that indicates the vehicle 100 is to be charged/discharged. If the monitoring module 220 determines the vehicle 100 is transferring charge, then the monitoring module 220 proceeds to block 430.

At 430, the monitoring module 220 determines an exchange rate for the transfer. In one embodiment, the monitoring module 220 determines the exchange rate according to the relationship (i.e., contract) between the vehicle 100 and the station, current market rates, previous behaviors of the vehicle 100 (e.g., charging during peak demand), a source of stored power (e.g., renewable vs fossil-based), and so on. Accordingly, the exchange rate provided for power that is stored into the internal battery or provided by the vehicle 100 can fluctuate depending on various conditions surrounding the transfer.

The transfer system 170 and the station are configured, in one approach, to use a token ecosystem as a means for exchanging payment for the electric. That is, the transfer system 170 in coordination with the station use an electronic form of currency to execute the exchange of payment for the electricity. The electronic currency is, for example, a blockchain-based cryptocurrency that can function in a distributed manner without a centralized clearinghouse. Thus, the electronic currency is Bitcoin or a similar electronic cryptocurrency that can be exchanged directly between two parties electronically.

At 440, the monitoring module 220 determines whether tokens will actually be exchanged for the transfer. That is, because payment may occur upon initiation of an agreement, or subsequently in fulfillment of a credit obligation, tokens may not always be exchanged when electric power is transferred. Accordingly, the monitoring module 220 checks for such conditions at 440 to ensure that proper payment in fulfillment of various agreements occurs.

At 450, the monitoring module 220 executes the exchange of tokens according to the exchange rate. In one embodiment, the monitoring module 220 further meters the exchange according to kilowatt-hours transferred and executes the transfer according to the metered amount. In general, the exchange can occur through the vehicle 100 providing the station with tokens or by the station providing the vehicle 100 with tokens. For example, the monitoring module 220 can facilitate exchanges for payment between the vehicle 100 and the station by receiving tokens upon providing the internal battery at predefined times to store surplus electric as a service to the location associated with the station, providing tokens as payment for the electric charge when not fulfilling an agreement, receiving tokens upon discharging electric to the station in fulfillment of an agreement, and so on.

Moreover, in further aspects, the transfer system 170 can exchange the tokens for dry goods, services, commodities (e.g., gasoline), tolls, food, and so on. Thus, the tokens provide a convenient electronic form of payment between entities that function for more than the transfer of electric power.

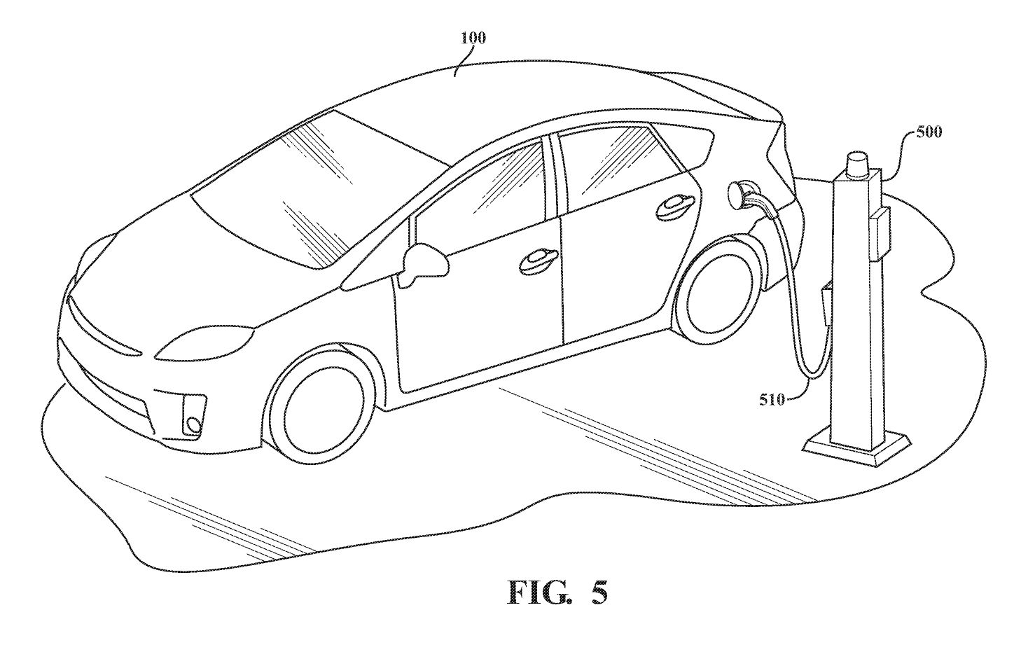

Further aspects of the transfer system 170 will be discussed along with examples of the subsequent FIGS. 5-7. For example, FIG. 5 illustrates an example circumstance of the vehicle 100 connected with a charging station 500 via a charging cable 510. In the illustrated configuration the transfer system 170 would have detected the event of the cable 510 being engaged with a connector of the vehicle 100. Thus, the transfer system 170 generally executes the functions noted in connection with methods 300 and 400 in a parallel manner such that attributes about the station, a relationship between the station and the vehicle 100, exchange rates, and so on are known and transfer of electric can occur.

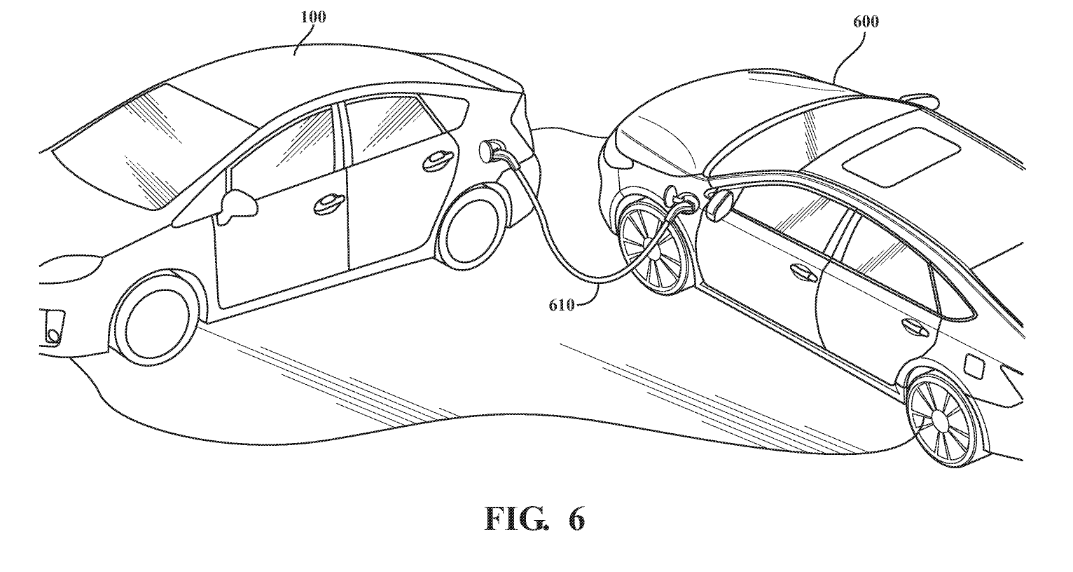

FIG. 6 illustrates a further configuration for the vehicle 100 connected with another vehicle 600 via a charging cable 610. In this circumstance, the transfer system 170 initiates the methods 300 and 400 in relation to the vehicle 600 in place of the previously noted station. Thus, the transfer system 170 is not limited to interacting with and facilitating the transfer of electric with just a station but also with other vehicles or devices that include compatible connections.

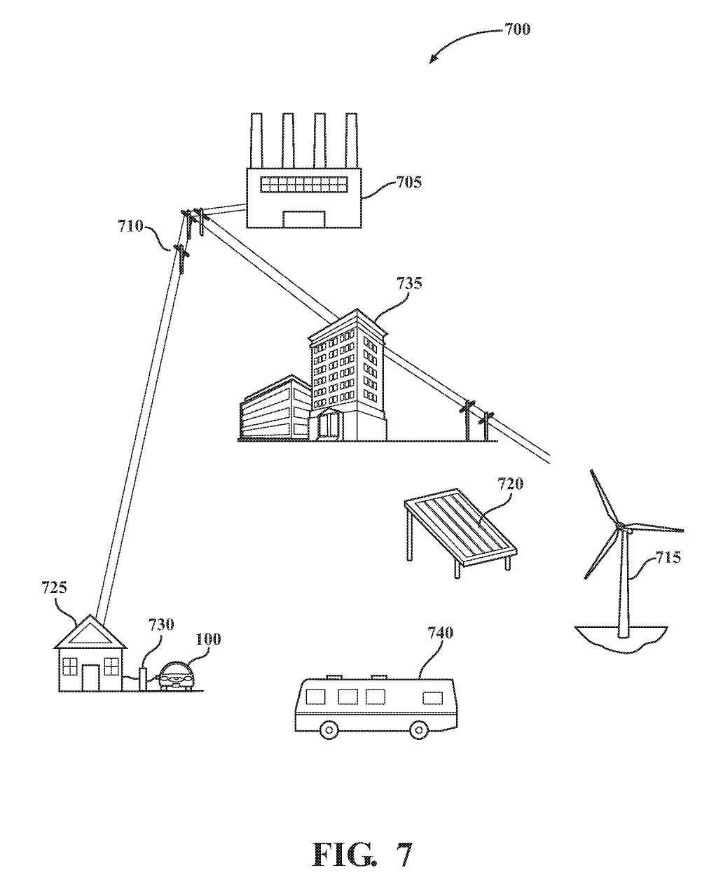

FIG. 7 illustrates an example configuration of various infrastructure and electric sources in the form of map 700. As illustrated, the map 700 includes what may be considered to be traditional electric utility grid elements including a source of power as the coal power plant 705 and transmission lines 710. Of course, in further aspects, the transmission lines 710 can also provide electric from renewable sources of energy such as windmills 715, photovoltaic cells 720, or other renewable sources such as hydroelectric. It should be noted that some of the noted sources fluctuate in the production of power depending on various environmental conditions. That is, the photocells 720 generally peak in production around mid-day while the windmills 715 may peak at night or more directly with particular weather patterns. Thus, the noted systems can facilitate temporally shift the power provided by these sources.

Additionally, the map 700 further illustrates various load components that may exist within a power grid. That is, the map depicts a residence 725 connected with the transmission lines 710. The residence represents a generic consumer of electricity and, as illustrated, includes a station 730, which may be used by the vehicle 100 to either acquire electric charge for the internal battery or to provide electric back into the transmission lines for use by neighbors or other loads with the grid. Moreover, the map is further illustrated with office buildings 735, which represent loads that vary in peak demand in relation to the residence 725. That is, the office buildings peak during daytime hours, while the residence peak during evening hours. Of course, overall peak demand typically occurs during evening hours; however, this local effect represents how the vehicle 100 and similar vehicles can be utilized in micro or macro environments to shift energy from peak production to peak demand and thus offset the demand.

Accordingly, as one example, the vehicle 100 can be charged overnight. Thus, when an operator commutes and parks the vehicle 100 at the office buildings 735, extra charge int eh battery of the vehicle 100 can be discharged to offset demand at the buildings 735. Similarly, if supplies of power are abundant at the buildings 735 as may be the case if a parking garage in which the vehicle 100 is parked is covered in solar cells 720, then the vehicle 100 can be charged during daytime hours while the operator is at work and used to subsequently discharge power at the residence 725 and offset demand.

As a further matter, this arrangement of charging and discharging in various locations can be contracted for as noted previously and therefore made more reliable and also induce further participation from additional vehicles via incentives provided through payment using the disclosed token ecosystem. As a further example, the charging and discharging can be implemented independently of the grid through off-grid renewable charging sources and through discharging to various off-grid entities such as RV 740, other vehicles, and/or various infrastructure (e.g., off-grid residences). In this way, the transfer system 170 improves the distribution of power between various locations and also temporally to offset demand and production.

As an additional matter in reference to the previously discussed blockchain-based cryptocurrency, in one embodiment, the blockchain-based cryptocurrency disclosed herein is linked with a particular vehicle. For example, when a vehicle is initially manufactured, an identifier in the form of a unique identifier such as a digital certificate is generated for the vehicle. The digital certificate includes unique identifying information and may include a unique private cryptographic key, an asymmetric key pair, or another unique form of identification. The unique identifier forms the basis of the vehicle in the blockchain based cryptocurrency and more specifically within a distributed tamper-proof ledger that is incorruptible and immutable because of the provided cryptographic information.

Accordingly, the unique identifier in combination with the distributed ledger form a basis for ensuring the integrity of data associated with the vehicle and provided between the vehicle and other parties in either a peer-to-peer (P2P) configuration or through a centralized mechanism. In either case, the unique identifier that is blockchain-based provides for ensuring the integrity of accounts and other information associated with the vehicle.

By way of example, the vehicle and/or a user thereof can leverage the unique identifier to provide a digital wallet that holds currencies (e.g., tokens) and supports peer-to-peer transactions using the currencies. Additionally, the unique identifier can provide for ensuring the integrity of vehicle identification information, ownership, specifications, repair/maintenance records, recorded vehicle data (e.g., telematics data), and so on. Thus, the identifier can ensure the parts within the vehicle are original or verified replacements, prevent odometer manipulation and manipulation of service records and other information, ensure the integrity of telematics data as being from the vehicle, and so on.

Providing for the integrity of such information in this way can improve the value of the vehicle and/or the data. Thus, the owner of the vehicle may leverage the authenticity of the telematics data to sell the data in a similar fashion as discussed in relation to the electric energy discussed previously (i.e., in a distributed P2P manner). Moreover, the identifier can provide for vehicle-to-vehicle payments and transactions, usage-based taxation (e.g., automated tax payments), usage-based infrastructure payments (e.g., pay tolls, parking, etc.), commercial vehicle platooning (e.g., autonomous trucks can pay a leading truck to follow its guidance and to draft on highways), and so on. Moreover, the identity can be leveraged to authenticate data about the vehicle to insurance providers such that insurance can be acquired and transacted for according to usage of the vehicle as authenticated via the unique identifier. As an added matter, the blockchain-based identity can provide for other transactions in relation to the vehicle such as decentralized ride-sharing, car sharing, and so on.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system or a geolocation system.

The processor(s) 110, the transfer system 170, and/or the autonomous driving module(s) 160 can be operatively connected to communicate with the various vehicle systems 140 and/or individual components thereof. For example, returning to FIG. 1, the processor(s) 110 and/or the autonomous driving module(s) 160 can be in communication to send and/or receive information from the various vehicle systems 140 to control the movement, speed, maneuvering, heading, direction, etc. of the vehicle 100. The processor(s) 110, the transfer system 170, and/or the autonomous driving module(s) 160 may control some or all of these vehicle systems 140 and, thus, may be partially or fully autonomous.

The processor(s) 110, the transfer system 170, and/or the autonomous driving module(s) 160 can be operatively connected to communicate with the various vehicle systems 140 and/or individual components thereof. For example, returning to FIG. 1, the processor(s) 110, the transfer system 170, and/or the autonomous driving module(s) 160 can be in communication to send and/or receive information from the various vehicle systems 140 to control the movement, speed, maneuvering, heading, direction, etc. of the vehicle 100. The processor(s) 110, the transfer system 170, and/or the autonomous driving module(s) 160 may control some or all of these vehicle systems 140.

The processor(s) 110, the transfer system 170, and/or the autonomous driving module(s) 160 may be operable to control the navigation and/or maneuvering of the vehicle 100 by controlling one or more of the vehicle systems 140 and/or components thereof. For instance, when operating in an autonomous mode, the processor(s) 110, the transfer system 170, and/or the autonomous driving module(s) 160 can control the direction and/or speed of the vehicle 100. The processor(s) 110, the transfer system 170, and/or the autonomous driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine position and velocity of the vehicle 100. The autonomous driving module(s) 160 can determine the location of obstacles, obstacles, or other environmental features including traffic signs, trees, shrubs, neighboring vehicles, pedestrians, etc.

The autonomous driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving module(s) 160 either independently or in combination with the transfer system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the object models 250 as implemented by the charging module 230. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 160 can be configured can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A transfer system for improving distribution of power using an internal battery of an electric vehicle, comprising:
one or more processors;
a memory communicably coupled to the one or more processors and storing:
a monitoring module including instructions that when executed by the one or more processors cause the one or more processors to, in response to detecting establishment of an electrical connection between the electric vehicle and a station, determine attributes of the electrical connection with the station that indicate at least a relationship between the electric vehicle and the station; and
a charging module including instructions that when executed by the one or more processors cause the one or more processors to transfer electric charge between an internal battery of the electric vehicle and the station according to at least the attributes of the electrical connection by performing one of:
i) discharging the electric charge to the station from the internal battery to offset electric demand at a location associated with the station according to the relationship, and
ii) charging the internal battery of the vehicle from the station to store surplus electric supply.

2. The transfer system of claim 1, wherein the charging module includes instructions to transfer the electric charge independently of an electric utility grid, and wherein the relationship indicates a futures contract between the electric vehicle and the location associated with the station for exchanging the electric charge for payment.

3. The transfer system of claim 2, wherein the payment includes using a decentralized form of monetization that is a blockchain-based cryptocurrency, and wherein the futures contract indicates a defined schedule of transfers of the electric charge to the station from the vehicle and from the station to the vehicle.

4. The transfer system of claim 2, wherein the monitoring module further includes instructions to:
exchange tokens as the payment between the vehicle and the station according to at least the attributes by:
i) receiving, by the vehicle, the tokens upon providing the internal battery at predefined times to store the surplus electric supply as a service to the location associated with the station as a function of the relationship,
ii) providing, from the vehicle, the tokens as payment for the electric charge when not fulfilling the relationship, and
iii) receiving, by the vehicle, the tokens upon discharging the electric charge to the station in fulfillment of the relationship, wherein the relationship defines exchange rates for transferring the electric charge; and
exchange, by the vehicle with a provider, the tokens for one or more of: a toll, and dry goods.

5. The transfer system of claim 1, wherein the monitoring module further includes instructions to determine an exchange rate for transferring the electric charge according to at least the attributes, wherein the exchange rate is a function of the relationship, a time of day, and an available supply of electric.

6. The transfer system of claim 1, wherein the monitoring module includes instructions to determine the attributes including instructions to determine a score indicating at least previous behavior of the vehicle in relation to transferring the electric charge and fulfilling obligations under the relationship, and wherein the charging module includes instructions to transfer the electric charge based, at least in part, on the score.

7. The transfer system of claim 1, wherein the monitoring module includes instructions to detect the establishment of the electrical connection including instructions to detect a charging cable of the vehicle being connected with a connector of the station, wherein the station is independent of an electric grid, and
wherein the monitoring module includes instructions to determine the attributes including instructions to identify physical characteristics of the connection and policy characteristics of the connection.

8. The transfer system of claim 7, wherein the policy characteristics control how the vehicle charges from and discharges to the station, and wherein the policy characteristics indicate aspects of the relationship between the station and the vehicle.

9. A non-transitory computer-readable medium for improving distribution of power using an internal battery of an electric vehicle and including instructions that when executed by one or more processors cause the one or more processors to:
in response to detecting establishment of an electrical connection between the electric vehicle and a station, determine attributes of the electrical connection with the station that indicate at least a relationship between the electric vehicle and the station; and
transfer electric charge between an internal battery of the electric vehicle and the station according to at least the attributes of the electrical connection by performing one of:
i) discharging the electric charge to the station from the internal battery to offset electric demand at a location associated with the station according to the relationship, and
ii) charging the internal battery of the vehicle from the station to store surplus electric supply.

10. The non-transitory computer-readable medium of claim 9, wherein the instructions to transfer the electric charge include instructions to transfer the electric charge independently of an electric utility grid, and wherein the relationship indicates a futures contract between the electric vehicle and the location associated with the station for exchanging the electric charge for payment.

11. The non-transitory computer-readable medium of claim 10, wherein the payment includes using a decentralized form of monetization that is a blockchain-based cryptocurrency, and wherein the futures contract indicates a defined schedule of transfers of the electric charge to the station from the vehicle and from the station to the vehicle.

12. The non-transitory computer-readable medium of claim 10, wherein the instructions further includes instructions to:
exchange tokens as the payment between the vehicle and the station according to at least the attributes by:
i) receiving, by the vehicle, the tokens upon providing the internal battery at predefined times to store the surplus electric supply as a service to the location associated with the station as a function of the relationship,
ii) providing, from the vehicle, the tokens as payment for the electric charge when not fulfilling the relationship, and
iii) receiving, by the vehicle, the tokens upon discharging the electric charge to the station in fulfillment of the relationship, wherein the relationship defines exchange rates for transferring the electric charge; and
exchange, by the vehicle with a provider, the tokens for one or more of: a toll, and dry goods.

13. The non-transitory computer-readable medium of claim 9, wherein the instructions further include instructions to determine an exchange rate for transferring the electric charge according to at least the attributes, wherein the exchange rate is a function of the relationship, a time of day, and an available supply of electric, wherein the instructions to determine the attributes include instructions to determine a score indicating at least previous behavior of the vehicle in relation to transferring the electric charge and fulfilling obligations under the relationship, and wherein the instructions to transfer the electric charge include instructions to transfer the electric charge based, at least in part, on the score.

14. A method for improving distribution of power using an internal battery of an electric vehicle, comprising:
in response to detecting establishment of an electrical connection between the electric vehicle and a station, determining attributes of the electrical connection with the station that indicate at least a relationship between the electric vehicle and the station; and
transferring electric charge between an internal battery of the vehicle and the station according to at least the attributes of the electrical connection by performing one of:
i) discharging the electric charge to the station from the internal battery to offset electric demand at a location associated with the station according to at least the relationship, and
ii) charging the internal battery of the vehicle from the station to store surplus electric supply.

15. The method of claim 14, wherein transferring the electric charge includes analyzing the attributes to identify characteristics of the transferring including whether the transferring is a discharge to the station or a charging of the internal battery and an amount of the electric charge that is to be transferred, wherein transferring the electric charge is independent of an electric utility grid, and wherein the relationship indicates a futures contract for exchanging the electric charge for payment.

16. The method of claim 15, wherein the payment includes using a decentralized form of monetization that is a blockchain-based cryptocurrency, and wherein the futures contract indicates a defined schedule of transfers of the electric charge to the station from the vehicle and from the station to the vehicle.

17. The method of claim 15, further comprising:
exchanging tokens as the payment between the vehicle and the station according to at least the attributes by:
i) receiving, by the vehicle, tokens upon providing the internal battery at predefined times to store the surplus as a service to the location associated with the station as a function of the relationship,
ii) providing, from the vehicle, the tokens as payment for the electric charge when not fulfilling the relationship, and
iii) receiving, by the vehicle, the tokens upon discharging the electric charge to the station in fulfillment of the relationship wherein the relationship defines exchange rates for transferring the electric charge; and
exchanging, by the vehicle with a provider, the tokens for one or more of: a toll, and dry goods.

18. The method of claim 14, further comprising:
determining an exchange rate for transferring the electric charge according to at least the attributes, wherein the exchange rate is a function of the relationship, a time of day, and an available supply of electric.

19. The method of claim 14, wherein determining the attributes includes determining a score indicating at least previous behavior of the vehicle in relation to transferring the electric charge and fulfilling obligations under the relationship, and wherein transferring is based, at least in part, on the score.

20. The method of claim 14, wherein detecting the establishment of the electrical connection includes detecting a charging cable of the vehicle being connected with a connector of the station, wherein the station is independent of an electric grid, wherein determining the attributes includes identifying physical characteristics of the connection and policy characteristics of the connection, wherein the policy characteristics control how the vehicle charges from and discharges to the station, and
wherein the policy characteristics indicate aspects of the relationship between the station and the vehicle.
